(19) United States
(12) Patent Application Publication
(10) Pub. No.: US 2022/0320519 A1
(43) Pub. Date: Oct. 6, 2022

(54) METHOD FOR MANUFACTURING ELECTRODE SLURRY FOR SECONDARY BATTERY, AND ELECTRODE INCLUDING THE SAME

(71) Applicant: SK INNOVATION CO., LTD., Seoul (KR)

(72) Inventors: Byoung Ho KO, Daejeon (KR); Jeong A KIM, Daejeon (KR); Joon Yeob LEE, Daejeon (KR); Jae Kyu JIN, Daejeon (KR)

(21) Appl. No.: 17/685,743

(22) Filed: Mar. 3, 2022

(30) Foreign Application Priority Data
Mar. 30, 2021 (KR) 10-2021-0041346

(51) Int. Cl. H01M 4/62; H01M 4/48; H01M 4/04; H01M 10/0525

(52) U.S. Cl. CPC H01M 4/625; H01M 4/48; H01M 4/04; H01M 10/0525; H01M 2004/027

(57) ABSTRACT

Provided is a method for manufacturing electrode slurry including: a) kneading a first mixture including an electrode active material and a thickener solution; and b) preparing a second mixture including the kneaded first mixture and a conductive agent, in which a solid content in the second mixture is smaller than that of the first mixture.

### CROSS-REFERENCE TO RELATED APPLICATIONS

This application claims priority under 35 U.S.C. § 119 to Korean Patent Application No.10-2021-0041346, filed on Mar. 30, 2021, in the Korean Intellectual Property Office, the disclosure of which is incorporated herein by reference in its entirety.

### TECHNICAL FIELD

The following disclosure relates to relates to a method for manufacturing electrode slurry for a secondary battery, and an electrode including the same.

### BACKGROUND

To cope with the global warming issue, which is a problem in modern society, the demand for eco-friendly technologies is rapidly increasing. In particular, as the technological demand for electric vehicles and an energy storage system (ESS) increases, the demand for lithium secondary batteries, which are spotlighted as energy storage devices, is also increasing explosively. Accordingly, studies to improve life characteristics of lithium secondary batteries are being conducted.

In general, electrode slurry for a lithium secondary battery is manufactured by mixing and dispersing an electrode active material, a conductive agent, and a binder in a solvent. In this case, in order to manufacture electrode slurry in which each composition is dispersed as uniformly as possible, a dispersion method using a strong shear force has been applied. However, in the process of manufacturing the electrode slurry, a structure of the conductive agent is destroyed by the strong shear force, and thus, there is a problem that initial conductivity may no longer be maintained. This problem is particularly serious as a long-term charging/discharging cycle progresses, and as a result, the life characteristics according to the cycle are significantly reduced.

Accordingly, research and development are needed to ensure uniform dispersion of each composition in electrode slurry and to minimize a decrease in conductivity due to a structural destruction of a conductive agent.

### SUMMARY

An embodiment of the present invention is directed to improving the problem of a decrease in conductivity due to a structural destruction such as fracture or bending of a conductive agent in a dispersion process using a strong shear force during a process of manufacturing electrode slurry for a secondary battery.

Another embodiment of the present invention is directed to improving resistance and life characteristics of an electrode manufactured from electrode slurry by improving rheological properties of the slurry through uniform dispersion of a conductive agent and an active material during a process of manufacturing the electrode slurry for a secondary battery.

In one general aspect, a method for manufacturing electrode slurry includes: a) kneading a first mixture including an electrode active material and a thickener solution; and b) preparing a second mixture including the kneaded first mixture and a conductive agent, in which a solid content in the second mixture is smaller than that of the first mixture.

The kneading may be performed at a shear force of 60 Pa or more.

A solid content in the first mixture may be 55 to 70 wt %.

A solid content in the second mixture may be 35 to 55 wt %.

A viscosity of the kneaded first mixture may be 3000 to 20000 cP.

A viscosity of the second mixture may be 2000 to 15000 cP.

The method may further include: c) preparing a third mixture by mixing the second mixture and a binder.

A solid content in the third mixture may be 35 to 55 wt %.

The conductive agent may be at least one selected from the group consisting of carbon nanotube, acetylene black, carbon black, natural graphite, artificial graphite, Ketjen black, and carbon fiber.

The conductive agent may include single-walled carbon nanotube (SWCNT).

In another aspect, an electrode for a secondary battery includes: a current collector; and an electrode active material layer configured to be located on at least one surface of the current collector, and include an electrode active material, a conductive agent, and a binder, in which a content of the conductive agent in the electrode active material layer is 0.05 to 0.2 wt %, the conductive agent includes single-walled carbon nanotube (SWCNT) having a length of 5 μm or more, and a resistance of the electrode depending on a 4 point-probe measurement method is 3 Ω.cm or less.

The electrode active material may include a silicon oxide-based active material and a carbon-based active material in a weight ratio of 20:80 to 5:95.

The electrode may include a negative electrode.

A 100-cycle capacity retention rate of a lithium secondary battery including the electrode may be 92% or more.

According to still another aspect of the present invention, there is provided a secondary battery including: the electrode as described above; a separator; and an electrolyte.

### BRIEF DESCRIPTION OF DRAWINGS

FIGS. 1A and 1B are diagrams illustrating a scanning electron microscope image of carbon nanotube (CNT). FIG. 1A illustrates a scanning electron microscope image of the CNT when a conductive agent is uniformly dispersed in a solvent, and FIG. 1B illustrates a scanning electron microscope image of the CNT when a strong external force is applied.

FIG. 2 is a diagram illustrating life characteristics of a secondary battery including an electrode manufactured according to an example of the present invention and Comparative Example 1.

### DETAILED DESCRIPTION OF EMBODIMENTS

Various advantages and features of the present disclosure and methods accomplishing them will become apparent from the following description of embodiments with reference to the accompanying drawings. However, the present disclosure is not limited to exemplary embodiments to be described below, but may be implemented in various different forms, these exemplary embodiments will be provided only in order to make the present disclosure complete and allow those skilled in the art to completely recognize the scope of the present disclosure, and the present disclosure will be defined by the scope of the claims. Hereinafter, exemplary embodiments of the present invention will be described in detail with reference to the accompanying drawings. Irrespective of the drawings, like reference numbers refer to like elements, and “and/or” includes each and one or more combinations of the recited items.

Unless defined otherwise, all terms (including technical and scientific terms) used in the present specification have the same meaning as meanings commonly understood by those skilled in the art to which the present invention pertains. Throughout the present specification, unless described to the contrary, “including” any component will be understood to imply the inclusion of other elements rather than the exclusion of other elements. In addition, a singular form includes a plural form unless specially described in the text.

When an element such as a layer, a film, a region, and a plate is “on” or “over” another component in the specification, it can be directly on the other element or intervening elements may be present therebetween.

In the present specification, “shear viscosity” and “shear stress” are values measured under a condition of a shear rate of 10s⁻¹ using a rotary rheometer at a slurry temperature of 25° C. In this case, tolerances are ±5 Cp and ±0.5 Pa, respectively.

The present invention provides a method for manufacturing electrode slurry including: a) kneading a first mixture including an electrode active material and a thickener solution; and b) preparing a second mixture including the kneaded first mixture and a conductive agent, in which a solid content in the second mixture is smaller than that of the first mixture.

In step a), the first mixture is prepared by mixing the electrode active material and the thickener solution, and then kneaded. In this case, the solid content in the first mixture may be 55 to 70 wt %, and preferably 58 to 68 wt %.

The kneading may be performed for 10 to 90 minutes, preferably 20 to 60 minutes, and more preferably 20 to 40 minutes at a shear force of 60 Pa or more, preferably 100 to 150 Pa. When the kneading process is performed within the above range, it is possible to uniformly disperse the electrode active material in the first mixture, so phase stability of the finally manufactured electrode slurry may be ensured. Accordingly, it is possible to reduce problems such as filter clogging during the manufacturing process due to a decrease in phase stability of slurry.

The electrode active material may be used without limitation as long as it is an electrode active material commonly used in a secondary battery. Examples of a negative electrode active material may be a carbon-based negative electrode active material, a silicon-based negative electrode active material, or a mixture thereof, but is not limited thereto. The carbon-based negative electrode active material may be one or more selected from artificial graphite, natural graphite, and hard carbon. The silicon-based negative electrode active material is Si, SiOₓ (0<x<2), an Si-Q alloy (wherein Q is an element selected from the group consisting of alkali metal, alkaline earth metal, group 13 element, group 14 element, group 15 element, group 16 element, transition metal, rare earth element, and a combination thereof, and not Si), a Si-carbon composite, or a mixture of at least one of them and SiO₂. The positive electrode active material may be a composite oxide of cobalt, manganese, nickel, and metal selected from a combination thereof and lithium, but is not limited thereto.

The thickener may be a cellulose-based compound, and specifically, one or more of carboxymethyl cellulose, hydroxypropylmethyl cellulose, methyl cellulose, alkali metal salts thereof, or the like may be mixed and used. As the alkali metal, Na, K, or Li may be used. In this case, the thickener may be mixed in a solution state in which a solid content is 0.5 to 2 wt %, and preferably 0.6 to 1.2 wt %.

The solvent may be used without limitation as long as it is a solvent typically used for electrode slurry. Specifically, the solvent for the negative electrode may be at least one selected from the group consisting of water, pure water, deionized water, distilled water, ethanol, isopropanol, methanol, acetone, n-propanol, and t-butanol, but is not limited thereto. The solvent for the positive electrode may be at least one selected from the group consisting of an amine-based solvent such as N,N-dimethylaminopropylamine and diethyltriamine; an ether-based solvent such as ethylene oxide and tetrahydrofuran; a ketone-based solvent such as methyl ethyl ketone; an ester-based solvent such as methyl acetate; and an aprotic polar solvent such as dimethylacetamide and N-methyl-2-pyrrolidone, but is not limited thereto.

In step b), the conductive agent is injected into the kneaded first mixture to prepare a second mixture. In this case, the solid content in the second mixture may be 35 to 55 wt %, preferably 40 to 50 wt %, and more preferably 40 to 46 wt %.

The viscosity of the kneaded first mixture at the time of injecting the conductive agent may be 3000 to 20000 cP, and preferably 5000 to 15000 cP at 25° C. In the above range, the electrode slurry in the state in which the conductive agent is uniformly dispersed may be prepared, and the fluidity of the finally manufactured slurry may be secured, and thus, applied on the current collector at a uniform thickness.

The viscosity of the second mixture prepared in step b) may be 2000 to 150000 cP, and preferably 3000 to 130000 cP.

The conventional electrode slurry for the second battery is manufactured by mixing and dispersing the electrode active material, the conductive agent, and the binder in the solvent. In this case, a dispersion method using a strong shear force is used for uniform distribution of each composition. During the dispersion process, the structure of the conductive agent is destroyed, resulting in a problem that the initial conductivity may no longer be maintained. This problem is particularly serious as a long-term charging/discharging cycle progresses, and as a result, the life characteristics according to the cycle are significantly reduced.

On the other hand, in the present invention, it is possible to improve the problem of the decrease in conductivity due to structural destruction of the conductive agent by injecting the conductive agent into the first mixture subjected to the kneading process.

Specifically, when the conductive agent including SWCNT is injected after the kneading process in step a), the length and straightness of the SWCNT may be maintained well without causing the problem of destroying the structure such as shortening or bending of the SWCNT due to the strong shear force during the kneading process. Accordingly, the conductivity of the SWCNT is maximally expressed, and thus, the resistance of the electrode manufactured using the electrode slurry including the same may be significantly reduced, and furthermore, the capacity retention rate according to a cycle of 92% or more may be exhibited.

The conductive agent may be at least one selected from the group consisting of carbon nanotube, acetylene black, carbon black, natural graphite, artificial graphite, Ketjen black, and carbon fiber, and the conductive agent may be injected in a solution state in which a solid content is 0.5 to 2 wt %, and preferably 0.5 to 1.8 wt %. According to an embodiment of the present invention, the conductive agent may include single-walled carbon nanotube (SWCNT).

After step b), step c) of preparing the third mixture by mixing the second mixture and the binder may be further performed.

The binder is not particularly limited as long as it is a conventional binder capable of well adhering the electrode active material particles to each other while well adhering the electrode active material to the current collector. For example, the binder may be an aqueous binder, specifically styrene-butadiene rubber, acrylated styrene-butadiene rubber, polyvinyl alcohol, sodium polyacrylate, a copolymer of propylene and olefin having 2 to 8 carbon atoms, a copolymer of (meth) acrylic acid and (meth) acrylic acid alkyl ester, or a combination thereof. In this case, the binder may be mixed in a solution state in which a solid content is 20 to 60 wt %, and preferably 30 to 50 wt %.

When using the aqueous binder, the aqueous binder may bind the electrode active material well to the current collector without affecting the viscosity of the slurry, but the slurry may easily gelled due to the electrode active material and conductive material, which are fine particles, and may further include the thickener for making the stable slurry by imparting the viscosity to the slurry. As an example of the thickener, a cellulose-based compound, and specifically, one or more of carboxymethyl cellulose, hydroxypropylmethyl cellulose, methyl cellulose, alkali metal salts thereof, or the like may be mixed and used. As the alkali metal, Na, K, or Li may be used.

The solid content in the third mixture may be 35 to 55 wt %, preferably 40 to 50 wt %, and more preferably 42 to wt %. Within the above range, the fluidity of the electrode slurry may be ensured, the slurry coating workability may be improved, and furthermore, an electrode having a uniform thickness may be manufactured.

The present invention provides an electrode for a secondary battery including: a current collector; and an electrode active material layer configured to be located on at least one surface of the current collector, and include an electrode active material, a conductive agent, and a binder, in which a content of the conductive agent in the electrode active material layer is 0.05 to 0.2 wt %, the conductive agent includes single-walled carbon nanotube (SWCNT) having a length of 5 μm or more, and a resistance of the electrode depending on a 4 point-probe measurement method is 3 Ω.cm or less. In this case, the resistance is the resistance of the electrode mixture layer, and refers to a value measured using a 4 point-probe resistance meter.

In general, in the case of the electrode for a secondary battery including the SWCNT, in the step of dispersing the electrode slurry during the process of manufacturing the electrode slurry, the length and straightness of the SWCNT are destroyed due to the strong shear force, and thus, there is a problem that the conductivity is significantly reduced. That is, the initial structure of the conductive agent in the electrode is not maintained, so the conductivity imparting effect is reduced and the high resistance is exhibited.

On the other hand, in the case of the electrode for a secondary battery according to the present invention, although the content of the conductive agent (SWCNT) in the electrode active material layer is 0.05 to 0.5 wt %, the initial length and straightness of the SWCNT may be maintained, thereby reducing the resistance of the electrode. Specifically, the resistance of the electrode is 3 Ω.cm or less, and preferably 2.5 to 3 Ω.cm, and the 100-cycle capacity retention rate of the lithium secondary battery including the electrode may be 92% or more.

The electrode may be a positive electrode or a negative electrode depending on the type of the electrode active material included in the electrode layer. The electrode active material may be used without limitation as long as it is an electrode active material commonly used in a secondary battery.

The positive electrode active material may be a composite oxide of cobalt, manganese, nickel, and metal selected from a combination thereof and lithium, but is not limited thereto.

Examples of the negative electrode active material may be a carbon-based negative electrode active material, a silicon-based active material, or a mixture thereof, but is not limited thereto. The carbon-based active material may be one or more selected from the group consisting of artificial graphite, natural graphite, and hard carbon. The silicon-based active material is Si, SiOₓ (0<x<2), an Si-Q alloy (wherein Q is an element selected from the group consisting of alkali metal, alkaline earth metal, group 13 element, group 14 element, group 15 element, group 16 element, transition metal, rare earth element, and a combination thereof, and not Si), a Si-carbon composite, or a mixture of at least one of them and SiO₂.

In an embodiment of the present invention, the electrode active material may include a silicon oxide-based active material (SiOₓ (0<x<2)) and a carbon-based active material in a weight ratio of 20:80 to 5:95, and preferably 15:85 to 10:90. In general, the Si material has a volume expansion characteristic, and in particular, as the charging/discharging process is performed for a long time, the problem becomes more severe. Accordingly, as an initial conductive path formed around the silicon oxide-based active material is destroyed, the performance degradation becomes more severe.

However, in the present invention, the straightness structure of the conductive agent in the electrode may be well maintained, and thus, the excellent life characteristics may be exhibited by suppressing the decrease in conductivity of the conductive agent due to the volume expansion of the silicon oxide-based active material.

In an embodiment of the present invention, the electrode may include a negative electrode. In this case, the electrode active material may include the negative active material described above, and the conductive agent and binder are the same as described above.

The present invention also provides a secondary battery including: the electrode according to one embodiment; a separator; and an electrolyte.

In detail, the electrode according to the present invention may have the improved conductivity and stability. Accordingly, the secondary battery including the electrode may have more improved long-term stability.

The separator is not particularly limited as long as it is a known separation membrane in the art. For example, it may be selected from glass fiber, polyester, polyethylene, polypropylene, polytetrafluoroethylene, or a combination thereof, and may be in the form of a non-woven fabric or a woven fabric, and may optionally be used in a single-layer or multi-layer structure.

The electrolyte includes a non-aqueous organic solvent and an electrolyte salt. The non-aqueous organic solvent is ethylene carbonate (EC), propylene carbonate (PC), dimethyl carbonate (DMC), diethyl carbonate (DEC), ethylmethyl carbonate (EMC), 1,2-dimethoxyethane (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO), acetonitrile (AN), or a mixture thereof, but is not limited thereto. The electrolyte salt is a material that is dissolved in the non-aqueous organic solvent, and thus, serves as a source of electrolytic metal ions in the battery to enable basic secondary battery operation, and promote the movement of electrolytic metal ions between the positive electrode and the negative electrode. As a non-limiting example, when the electrolytic metal is lithium, the electrolytic salt is LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂) (C_{y}F_{2y+1}SO₂) (however, x and y are natural numbers), LiCl, LiI, or a mixture thereof, but is not limited thereto. In addition, the electrolyte salt may use the known material in a concentration suitable for the purpose, and if necessary, may further include the known solvent or additive to improve charging/discharging characteristics, flame retardancy characteristics, and the like.

### EXAMPLE

### Example 1

Step 1: Manufacturing of Negative Electrode Slurry

A first mixture including 57.3 wt % of artificial graphite, 3.8 wt % of SiO, and 38.9 wt % of a CMC solution (1.2 wt % of solid content) was kneaded at a shear force of 100 Pa for 30 minutes. In this case, the solid content in the first mixture was 61.7 wt %.

Next, based on the total weight of the first mixture, 15.8 wt % of SWCNT (TUBALL BATT from Ocsial, H₂O: 0.2%, length: >5 μm, diameter: 1.4 to 2.2 nm) solution (1 wt % of solid content) and 29.6 wt % of CMC solution (1.2 wt % of solid content) were injected and then mixed at 100 rpm for 20 minutes to prepare a second mixture having 45.1 wt % of solid content.

Finally, based on the total weight of the first mixture, 2.7 wt % of an SBR binder solution (40 wt % of solid content) was injected and then mixed at 100 rpm for 10 minutes to prepare negative electrode slurry having 45.0 wt % of solid content.

The content of the conductive agent SWCNT in the prepared negative electrode slurry was 0.1 wt %.

Step 2: Manufacturing of Negative Electrode

The negative electrode slurry manufactured in step 1 was applied to a copper current collector (copper foil having a thickness of 8 μm) using a slot die coater. Then, the negative electrode active material layer was completed by being dried for 30 minutes in a drying furnace heated with hot air at 120° C. In this case, the thickness of the negative electrode active material layer was set to 50 μm.

Step 3: Manufacturing of Secondary Battery

The positive electrode was used as the prepared negative electrode and counter electrode, a PE separator was interposed between the negative electrode and the counter electrode, and the electrolyte was injected to produce a CR2016 coin cell, and the assembled coin cell was rested at room temperature for 3 to 24 hours. In this case, as the electrolyte, a lithium salt 1.0M LiPF₆ was mixed in an organic solvent (EC:EMC=3:7 Vol %), an electrolyte additive FEC 2 vol % was mixed, and as the positive electrode, a positive electrode manufactured by applying slurry including 98.3 wt % of Li[Ni_{0.6}Co_{0.2}Mn_{0.2}]O₂, 0.6 wt % of carbon black, and 1.1 wt % of a PVDF binder to an aluminum current collector (aluminum foil having a thickness of 12 μm) was used.

### Evaluation Example

Evaluation Example 1: Evaluation of Negative

Electrode Resistance according to Injection Timing of Conductive Agent

### Comparative Example 1

Comparative Example 1 was performed in the same manner as in Example 1, except that in step 1 of Example 1, the SWCNT solution was added during the kneading process of the first mixture having 61.7% of solid content, thereby manufacturing the negative electrode.

### Comparative Example 2

Comparative Example 2 was performed in the same manner as Comparative Example 1, except that in Comparative Example 1, the SWCNT solution was injected during the kneading process of the first mixture of 65.0 wt % instead of 61.7% of solid content, and the shear force was performed at 120 Pa during the kneading, thereby manufacturing the negative electrode.

(Evaluation Method)

Resistance Evaluation of Electrode Mixture Layer

The negative electrode slurry manufactured in Step 1 of Example 1 and Comparative Examples 1 and 2 was coated to a thickness of 200 μm on a PET film, and then, dried for 30 minutes in the drying furnace heated with hot air at 120° C. to prepare the electrode resistance measurement sample, and then, measure the resistance value of the electrode mixture layer with a 4 point-probe, and the results were shown in Table 1 below.

Measurement of Shear Viscosity and Shear Stress of Mixture after Injection of Conductive Agent

In Example 1 and Step 1 of Comparative Examples 1 and 2, the shear viscosity and shear stress were measured for the mixture (slurry) after the conductive agent SWCNT was injected. Specifically, the results measured at the shear rate of 10s⁻¹ using the rotary rheometer at a slurry temperature of 25° C. were shown in Table 1 below. In this case, the tolerances are ±5 Cp and ±0.5 Pa, respectively.

TABLE 1

| | | | Mixture after Injection of SWCNT | | | |
|---|---|---|---|---|---|---|
| | SWCNT | Injection | Shear | Shear | Solid | |
| | Content | Timing | Viscosity | Stress | Content | Resistance |
| | (wt %) | of SWCNT | (cP) | (Pa) | (%) | (Ω · cm) |
| Example 1 | 0.10% | After | 6917 | 69.17 | 45.1 | 2.762 |
| | | Kneading | | | | |
| Comparative | 0.10% | During | 14040 | 140.4 | 61.7 | 3.086 |
| Example 1 | | Kneading | | | | |
| Comparative | 0.10% | During | 16230 | 162.3 | 65.0 | 3.419 |
| Example 2 | | Kneading | | | | |

In Table 1, the SWCNT content refers to the content of SWCNT in the negative electrode slurry.

Referring to Table 1, it is analyzed that in Comparative Examples 1 and 2, the length and straightness of the conductive agent SWCNT are destroyed due to the strong shear force according to the kneading process, and thus, the conductivity decreases and the electrode resistance increases. On the other hand, in the case of Example 1, the SWCNT structure present in the negative electrode was well maintained, and the cathode resistance might be lowered.

Specifically, in the case of Example 1, it could be seen that as the conductive agent SWCNT is injected after the kneading process in which the strong shear force is applied, the length and straightness of the SWCNT are well maintained, and the resistance of the manufactured electrode has a low value.

In the case of Comparative Example 1, it was determined that as the conductive agent SWCNT is injected during the kneading process, the SWCNT structure no longer maintains its initial structure due to the strong shear force during the kneading process, and the problems such as the fracturing or bending of the SWCNT occurs to reduce the conductivity.

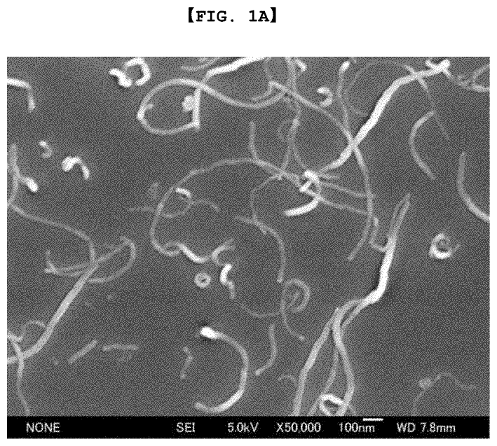

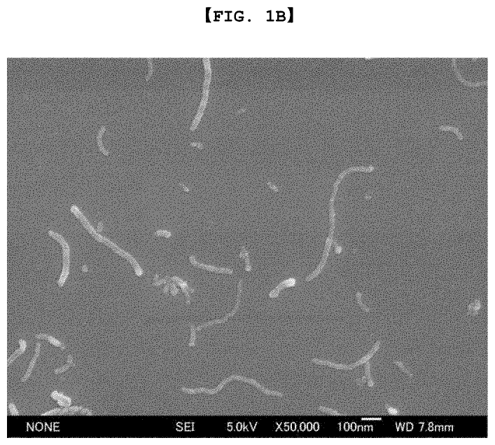

On the other hand, FIGS. 1A and 1B are diagrams illustrating the structural change of the conductive agent, in which FIG. 1A is a scanning electron microscope image of CNT when the conductive agent is uniformly dispersed in the solvent, and FIG. 1B illustrates a scanning electron microscope image of CNT when a strong external force is applied. In FIGS. 1A and 1B, it may be confirmed that the conductive agent CNT is fractured or bent due to the strong shear force.

In the case of Comparative Example 2, due to the stronger kneading shear force compared to Comparative Example 1, it exhibited a higher electrode resistance than Comparative Example 2. That is, it was determined that the structural destruction of the conductive agent SWCNT becomes more severe due to the strong shear force during the kneading process, and the conductivity significantly decreases.

### Evaluation Example 2: Evaluation of Life Characteristics

(Example 1, Comparative Example 1)

(Evaluation Method)

Evaluation of Cycle Life Characteristics

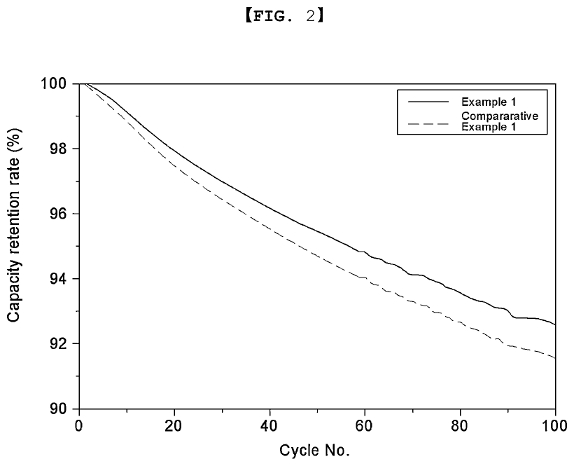

The batteries manufactured in Example 1 and Comparative Example 1 were charged with a constant current at room temperature (25° C.) at a current of 0.1C rate until the voltage reached 0.01V (vs. Li), and then was charged with a constant voltage by cutting off at a current of 0.01C rate while maintaining 0.01V in the constant voltage mode. The battery was discharged at a constant current of 0.1C rate until the voltage reached 1.5V (vs. Li). 1-cycle charging/discharging was performed, additional 1-cycle charging/discharging was performed in the same manner, and then 100-cycle charging/discharging was performed by changing the applied current to 0.3C during the charging/discharging, and there was a 10-minute pause between cycles. The life characteristics were measured using the 100-cycle discharge capacity with respect to the 1-cycle discharge capacity as the capacity retention rate (%), and the results were shown in FIG. 2 and Table 2 below.

TABLE 2

| | | | Resistance | Life |
|---|---|---|---|---|
| | SWCNT | Injection | of Electrode | Evaluation of |
| | Content | Timing | Mixture Layer | Coin Cell (%, |
| | (wt %) | of SWCNT | (Ω · cm) | @100 cycle) |
| Example 1 | 0.10% | After | 2.762 | 92.6 |
| | | Kneading | | |
| Comparative | 0.10% | During | 3.086 | 91.5 |
| Example 1 | | Kneading | | |

As can be seen in FIG. 2 and Table 2, in the case of Example 1 in which the SWCNT was injected into the kneaded first mixture, the viscosity of the mixture at the time of adding the conductive agent and the solid content in the mixture fell within the preferred range suggested by the present invention, and therefore, Example 1 exhibited a higher capacity retention rate compared to Comparative Example 1. These results indicate that silicon oxide and artificial graphite are uniformly dispersed in the slurry under the above conditions, thereby improving the stability of the slurry. Furthermore, it is determined that, depending on the injection timing of the conductive agent, the straightness structure of the conductive agent is well maintained, thereby suppressing the decrease in conductivity of the conductive agent due to the expansion of silicon oxide due to the charging/discharging.

In Comparative Example 1, as described above, since the conductive agent was injected before the kneading, it was determined that the resistance increases due to the structural destruction of the conductive agent during the kneading process, and thus, the capacity retention rate decreases.

According to a method for manufacturing electrode slurry for a secondary battery according to the present invention, it is possible to reduce the problem of a decrease in conductivity by maintaining a structure of a conductive agent well without the problem that the structure of the conductive agent is destroyed due to a strong shear force.

In addition, it is possible to remarkably improve resistance and life characteristics of a manufactured electrode by improving rheological properties of slurry through uniform dispersion of a conductive agent and an active material in electrode slurry.

Although the embodiments of the present invention have been described above, the present invention is not limited to the above embodiments, but may be manufactured in a variety of different forms, and those of ordinary skill in the art to which the present invention pertains will understand that the present invention may be implemented in other specific forms without changing the technical spirit or essential features of the present invention. Therefore, it should be understood that the above-described embodiments are exemplary in all aspects but are not limited thereto.

What is claimed is:

1. A method for manufacturing electrode slurry, comprising:
a) kneading a first mixture including an electrode active material and a thickener solution; and
b) preparing a second mixture including the kneaded first mixture and a conductive agent,
wherein a solid content in the second mixture is smaller than that of the first mixture.

2. The method of claim 1, wherein the kneading is performed at a shear force of 60 Pa or more.

3. The method of claim 1, wherein a solid content in the first mixture is 55 to 70 wt %.

4. The method of claim 1, wherein a solid content in the second mixture is 35 to 55 wt %.

5. The method of claim 1, wherein a viscosity of the kneaded first mixture is 3000 to 20000 cP.

6. The method of claim 1, wherein a viscosity of the second mixture is 2000 to 15000 cP.

7. The method of claim 1, further comprising:
c) preparing a third mixture by mixing the second mixture and a binder.

8. The method of claim 7, wherein a solid content in the third mixture is 35 to 55 wt %.

9. The method of claim 1, wherein the conductive agent is at least one selected from the group consisting of carbon nanotube, acetylene black, carbon black, natural graphite, artificial graphite, Ketjen black, and carbon fiber.

10. The method of claim 9, wherein the conductive agent includes single-walled carbon nanotube (SWCNT).

11. An electrode for a secondary battery, comprising:
a current collector; and
an electrode active material layer configured to be located on at least one surface of the current collector, and include an electrode active material, a conductive agent, and a binder,
wherein a content of the conductive agent in the electrode active material layer is 0.05 to 0.2 wt %,
the conductive agent includes single-walled carbon nanotube (SWCNT) having a length of 5 pm or more, and
a resistance of the electrode depending on a 4 point-probe measurement method is 3 Ω.cm or less.

12. The electrode of claim 11, wherein the electrode active material includes a silicon oxide-based active material and a carbon-based active material in a weight ratio of 20:80 to 5:95.

13. The electrode of claim 11, wherein the electrode includes a negative electrode.

14. The electrode of claim 11, wherein a 100-cycle capacity retention rate of a lithium secondary battery including the electrode is 92% or more.

15. A secondary battery comprising the electrode of claim 11.
